(19) United States
(12) Patent Application Publication
(10) Pub. No.: US 2013/0163191 A1
(43) Pub. Date: Jun. 27, 2013

(54) COMPUTER SYSTEM WITH AIR DUCT

(71) Applicants: LI-PING CHEN, Tu-Cheng (TW); SHENG-HUNG LEE, Tu-Cheng (TW); XIAN-HUANG GAO, Shenzhen City (CN)

(72) Inventors: LI-PING CHEN, Tu-Cheng (TW); SHENG-HUNG LEE, Tu-Cheng (TW); XIAN-HUANG GAO, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 13/595,341

(22) Filed: Aug. 27, 2012

(30) Foreign Application Priority Data
Dec. 27, 2011 (CN) 201110444185.1

(51) Int. Cl. G06F 1/20

(52) U.S. Cl. 361/679.46

(57) ABSTRACT

A computer system includes an enclosure, a printed circuit board, and an air duct. The enclosure comprises a bottom panel, a rear panel, and a mounting panel. The printed circuit board is mounted on the bottom panel and is located between the rear panel and the mounting panel. A plurality of expansion cards is inserted in the printed circuit board. The plurality of expansion cards is substantially parallel to each other. The air duct is placed on the rear panel and the mounting panel. The air duct comprises an air duct body and a guiding plate. The guiding plate comprises a securing portion secured to the air duct body and a plurality of bent elastic tabs extending from the securing portion at an angle. The plurality of bent elastic tabs resists the plurality of expansion cards, thereby guiding air to flow to the plurality of the expansion cards.

### BACKGROUND

1. Technical Field

The present disclosure relates to a computer system with an air duct.

2. Description of Related Art

Air ducts are commonly used for facilitating heat dissipation of electronic components of a computer system. The air duct covers the electronic components of the computer system to guide airflow from fans to the electronic components. For a large sized computer system, such as a server system, which has a great number of electronic components, a large sized air duct is needed to dissipate a massive amount of heat from electronic components. However, some space around the electronic components is empty, but the air still flows through the empty space, thus decreasing the dissipation efficiency.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a computer system in accordance with an embodiment.

FIG. 2 is an exploded, isometric view of an air duct of the computer system of FIG. 1.

FIG. 3 is an assembled view of the air duct of FIG. 2.

FIG. 4 is an assembled, isometric view of FIG. 1.

FIG. 5 is an assembled, isometric view of a computer system in accordance with another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

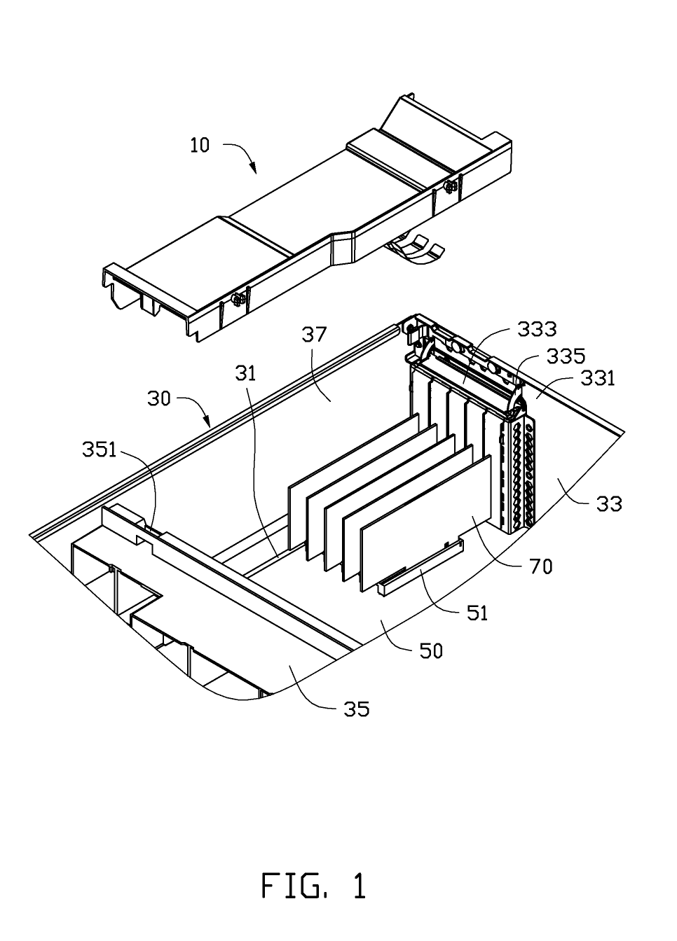

FIG. 1 is a computer system in accordance with an embodiment including an air duct 10, an enclosure 30, a printed circuit board 50, and a plurality of expansion cards 70. The plurality of expansion cards 70 is substantially parallel to each other.

The enclosure 30 includes a bottom panel 31, a rear panel 33 perpendicularly extending from the bottom panel 31, a mounting panel 35 mounted to the bottom panel 31, and a side panel perpendicularly extending from the bottom panel 31. The side panel 37 is substantially perpendicular to the rear panel 33. The mounting panel 35 is substantially parallel to the rear panel 33. The expansion cards 70 are substantially perpendicular to the rear panel 33. The rear panel 33 includes a rear panel body 331, a support panel 333 extending from the rear panel body 331 perpendicularly, and two connecting arms 335 connected between the support panel 333 and the rear panel body 331. Each connecting arm 335 is arc-shaped. The mounting panel 35 defines a positioning cutout 351.

The printed circuit board 50 is mounted to and is parallel to the bottom panel 31. The printed circuit board 50 includes a plurality of inserting slots 1 for receiving the expansion card 70.

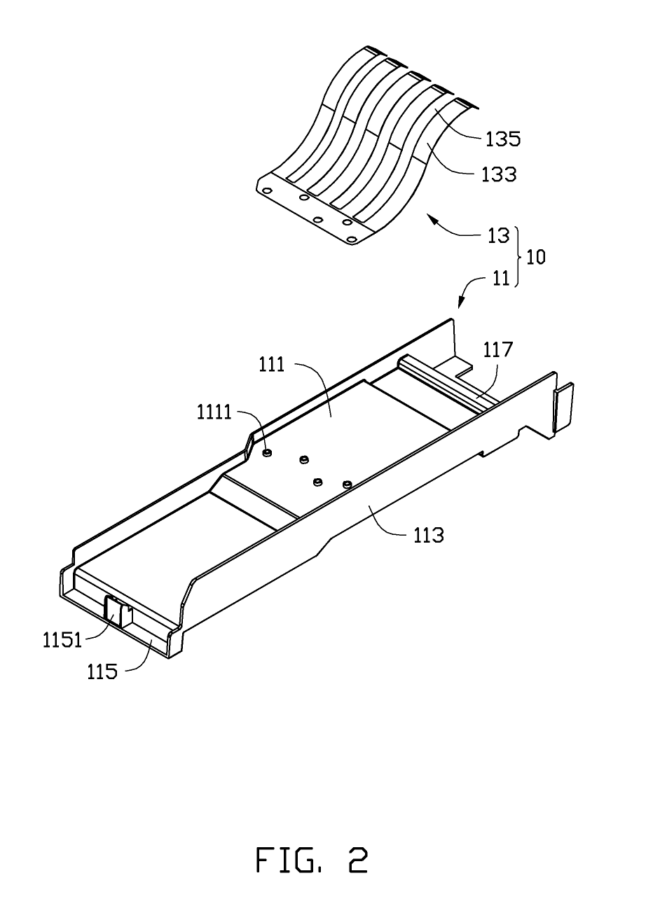

Referring to FIG. 2, the air duct 10 includes an air duct body 11 and a guiding plate 13 mounted to the air duct body 11. The air duct body 11 includes a top wall 111, two sidewalls 113 extending from the top wall 111, and a first mounting portion 115 and a second mounting portion 117, both extending from opposite sides of the top wall 111. The two sidewalls 113 are parallel to each other. The first mounting portion 115 includes a positioning protrusion 1151 corresponding to the positioning cutout 351. The second mounting portion 117 is placed on the support panel 333. The air duct body 11 further includes a plurality of securing protrusions 1111 extending from the inner side of the top wall 111. The guiding plate 13 includes a securing portion 131 and a plurality of elastic tabs 133 extending from the securing portion 131. A cap 135 is defined between two adjacent elastic tabs 133. Each elastic tab 133 is S-shaped. The securing portion 131 defines a plurality of securing holes 1311 corresponding to the securing protrusions 1111.

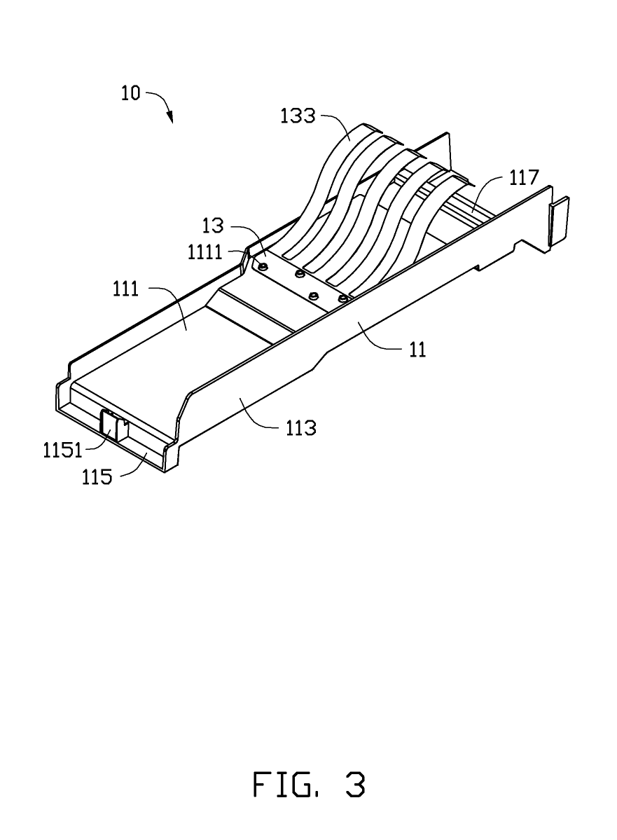

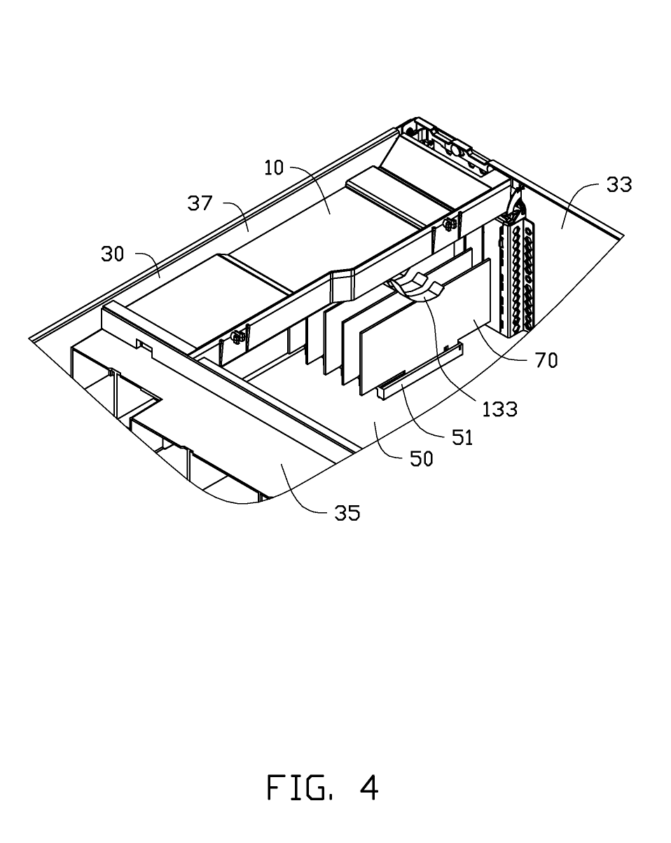

Referring to FIGS. 1 to 4, in assembly, the securing protrusions 1111 of the air duct body 11 are received in the securing holes of the guiding plate 13 and are secured with the securing holes via rivet joint. The first mounting portion 115 and the second mounting portion 117 of the air duct 10 correspond to the mounting panel 35 and the rear panel 33. At this time, the positioning protrusion 1151 of the first mounting portion 115 is aligned with the positioning cutout 351 of the mounting panel 35. The second mounting portion 117 is aligned with the support panel 333 of the rear panel 33. The elastic tabs 133 are aligned with the expansion cards 70. The air duct 10 moves downward to enable the positioning protrusion 1151 to be inserted in the positioning cutout 351. The second mounting portion 117 is placed on the support panel 333. At this time, the second mounting portion 117 is located between the two connecting arms 335. Each elastic tab 133 resists elastically against the corresponding expansion card 70.

In use, the elastic tabs 133 guide air to flow to the expansion cards 70 when air flows to the elastic tabs 133 of the air duct 10, thereby enhancing the dissipation efficiency.

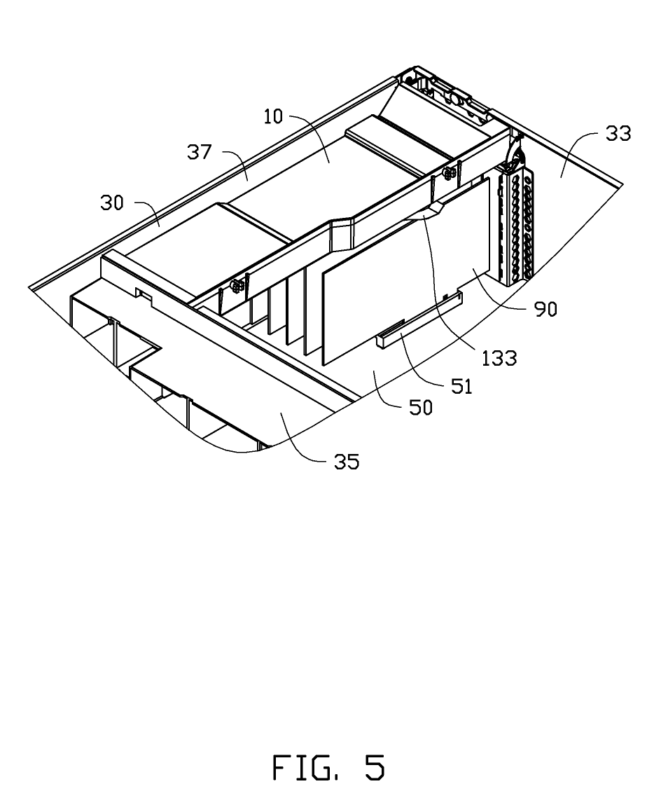

Referring to FIG. 5, the computer system includes a plurality of expansion cards 90 which are bigger than the expansion cards 70. The elastic tabs 133 resist against the plurality of expansion card 90.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A computer system comprising:
an enclosure, the enclosure comprises a bottom panel, a rear panel extending from the bottom panel, and a mounting panel mounted on the bottom panel;
a printed circuit board, the printed circuit board is mounted on the bottom panel and is located between the rear panel and the mounting panel; a plurality of expansion cards are inserted in the printed circuit board; and the plurality of expansion cards are substantially parallel to each other; and
an air duct, the air duct is placed on the rear panel and the mounting panel; the air duct comprises an air duct body and a guiding plate; the guiding plate comprises a securing portion secured to the air duct body and a plurality of bent elastic tabs extending from the securing portion at an angle; and the plurality of bent elastic tabs resists the plurality of expansion cards, thereby guiding air to flow to the plurality of expansion cards.

2. The computer system of claim 1, wherein the rear panel comprises a rear panel body, a support panel extending from the rear panel body, and a connecting arm connected between the support panel and the rear panel body; the support panel is substantially perpendicular to the rear panel body; and the air duct body is placed on the support panel.

3. The computer system of claim 2, wherein the connecting arm is arc-shaped.

4. The computer system of claim 1, wherein the air duct body comprises a top wall and two sidewalls extending from opposite sides of the top wall, and the guiding plate is secured to an inner side of the top wall.

5. The computer system of claim 4, wherein the top wall comprises a plurality of securing protrusions, and the securing portion defines a plurality of securing holes receiving the securing protrusions.

6. The computer system of claim 1, wherein the air duct body comprises a positioning protrusion, and the mounting panel defines a positioning cutout receiving the positioning protrusion.

7. The computer system of claim 1, wherein each bent elastic tab is S-shaped.

8. The computer system of claim 1, wherein the rear panel is substantially perpendicular to the bottom panel, and the rear panel is substantially parallel to the mounting panel.

9. The computer system of claim 8, wherein the enclosure further comprises a side panel perpendicularly extending from the bottom panel; the side panel is connected between the mounting panel and the rear panel; and the side panel is substantially parallel to the plurality of expansion cards.

10. The computer system of claim 1, wherein the printed circuit board is substantially parallel to the bottom panel, and the rear panel is substantially perpendicular to the plurality of expansion cards.

11. A computer system comprising:
an enclosure, the enclosure comprises a bottom panel, a rear panel extending from the bottom panel, and a mounting panel mounted on the bottom panel;
an air duct, the air duct is placed between the rear panel and the mounting panel; the air duct comprises an air duct body and a guiding plate; the guiding plate comprises a securing portion secured to an inner surface of the air duct body and a bent elastic tab extending from the securing portion at an angle; the bent elastic tab resists an expansion card mounted on the bottom panel, thereby guiding air to flow to the expansion card.

12. The computer system of claim 11, wherein the rear panel comprises a rear panel body, a support panel extending from the rear panel body, and a connecting arm connected between the support panel and the rear panel body; the support panel is substantially perpendicular to the rear panel body; and the air duct body is placed on the support panel.

13. The computer system of claim 12, wherein the connecting arm is arc-shaped.

14. The computer system of claim 11, wherein the air duct body comprises a top wall and two sidewalls extending from opposite sides of the top wall, and the guiding plate is secured to an inner side of the top wall.

15. The computer system of claim 14, wherein the top wall comprises a plurality of securing protrusions, and the securing portion defines a plurality of securing holes receiving the securing protrusions.

16. The computer system of claim 11, wherein the air duct body comprises a positioning protrusion, and the mounting panel defines a positioning cutout receiving the positioning protrusion.

17. The computer system of claim 11, wherein the bent elastic tab is S-shaped.

18. The computer system of claim 11, wherein the rear panel is substantially perpendicular to the bottom panel, and the rear panel is substantially parallel to the mounting panel.

19. The computer system of claim 18, wherein the enclosure further comprises a side panel extending from the bottom panel perpendicularly; the side panel is connected between the mounting panel and the rear panel; and the side panel is substantially parallel to the expansion card.

20. The computer system of claim 11, wherein the rear panel is substantially perpendicular to the expansion card.
